(19) United States
(12) Patent Application Publication
(10) Pub. No.: US 2024/0070596 A1
(43) Pub. Date: Feb. 29, 2024

(54) INFORMATION PROCESSING METHOD, INFORMATION PROCESSING DEVICE, AND RECORDING MEDIUM

(71) Applicant: Panasonic Intellectual Property Corporation of America, Torrance, CA (US)

(72) Inventors: Kotaro SAKATA, Osaka (JP); Tetsuji FUCHIKAMI, Osaka (JP)

(21) Appl. No.: 18/386,415

(22) Filed: Nov. 2, 2023

Related U.S. Application Data
(63) Continuation of application No. PCT/JP2022/003593, filed on Jan. 31, 2022.

(30) Foreign Application Priority Data
May 12, 2021 (JP) 2021-080718

(51) Int. Cl. G06Q 10/0639

(52) U.S. Cl. CPC G06Q 10/06398

(57) ABSTRACT

An information processing method includes: obtaining design information regarding work, the design information including a reference value and an acceptable range that includes the reference value; identifying a difference between the design information obtained and measured information regarding the work by comparing the design information with the measured information, the measured information being obtained from an image obtained by capturing an object on which the work has been performed; and providing a notification to a user when the difference identified falls within a given range that is in a neighborhood of an upper limit or a lower limit of the acceptable range.

### CROSS REFERENCE TO RELATED APPLICATIONS

This is a continuation application of PCT International Application No. PCT/JP2022/003593 filed on Jan. 31, 2022, designating the United States of America, which is based on and claims priority of Japanese Patent Application No. 2021-080718 filed on May 12, 2021. The entire disclosures of the above-identified applications, including the specifications, drawings and claims are incorporated herein by reference in their entirety.

### FIELD

The present disclosure relates to an information processing method, an information processing device, and a recording medium.

### BACKGROUND

A system that efficiently determines progress of construction work, for example, has been disclosed (see Patent Literature (PTL) 1).

### CITATION LIST

### Patent Literature

PTL 1: Japanese Patent No. 6700580

### SUMMARY

### Technical Problem

However, the quality of work may not be managed efficiently.

In view of this, the present disclosure provides an information processing method and so on that support efficient management of the quality of work.

### Solution to Problem

An information processing method according to one aspect of the present disclosure includes: obtaining design information regarding work, the design information including a reference value and an acceptable range that includes the reference value; identifying a difference between the design information obtained and measured information regarding the work by comparing the design information with the measured information, the measured information being obtained from an image obtained by capturing an object on which the work has been performed; and providing a notification to a user when the difference identified falls within a given range that is in a neighborhood of an upper limit or a lower limit of the acceptable range. Note that these general or specific aspects may be implemented as a system, a device, an integrated circuit, a computer program, or a computer-readable recording medium such as a CD-ROM, or may be implemented as any combination of systems, devices, integrated circuits, computer programs, and recording media.

### Advantageous Effects

The information processing method according to the present disclosure can support efficient management of the quality of work.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a configuration of a support system according to an embodiment.

FIG. 2 is a block diagram illustrating a functional configuration of a support device according to the embodiment.

FIG. 3 is a schematic diagram illustrating an appearance of a pillar, which is an example of a target object of work.

FIG. 4 is an explanatory table illustrating an example of design information in the embodiment.

FIG. 5 is an explanatory table illustrating an example of work information in the embodiment.

FIG. 6 is an explanatory diagram illustrating a first example of a monitoring range in the embodiment.

FIG. 7 is an explanatory diagram illustrating a second example of the monitoring range in the embodiment.

FIG. 8 is a schematic diagram illustrating an example of measured information in the embodiment.

FIG. 9 is a table illustrating an example of proficiency level information in the embodiment.

FIG. 10 is a flowchart illustrating a support method according to the embodiment.

### DESCRIPTION OF EMBODIMENT

### Underlying Knowledge Forming Basis of the Present Disclosure

The present inventors have found that the management of the quality of work mentioned in the “Background” section has the following problems.

At work sites such as construction sites, a significant amount of work is performed by many workers. The proficiency levels in each work of many workers vary. Therefore, it is common that the quality of work varies based on the proficiency level of each worker and each work.

In order to maintain the quality of work at least a certain level, the quality of a target object on which work has been performed (also simply referred to as an object) has been inspected conventionally. However, inspecting the quality of all objects at a site where a significant amount of work is being performed would take a great deal of time and leads to delays in construction. In addition, inspection of the quality requires significant hardware resources or power consumption. In addition, it is assumed that some of the objects will be extracted and inspected in some way, but it may not be possible to detect an object having a quality less than a certain quality. This may result in that the work of a quality less than the certain quality may remain without being detected.

As described above, there may be cases where the quality of work cannot be managed efficiently.

In view of this, the present disclosure provides an information processing method and so on that support efficient management of the quality of work.

An information processing method according to one aspect of the present disclosure includes: obtaining design information regarding work, the design information including a reference value and an acceptable range that includes the reference value; identifying a difference between the design information obtained and measured information regarding the work by comparing the design information with the measured information, the measured information being obtained from an image obtained by capturing an object on which the work has been performed; and providing a notification to a user when the difference identified falls within a given range that is in a neighborhood of an upper limit or a lower limit of the acceptable range.

With this aspect, the information processing method provides a notification to the user when the difference between the design information and the measured information is included in the given range. Therefore, the user can check the quality of the object on which the work corresponding to the notification has been performed with relatively high attention, and can focus on checking the object of the work. In addition, the user can check the quality of the work performed on the object by checking the quality of the object. As described above, the information processing method can support efficient management of the quality of work.

In other words, if the user checks the quality of more objects with relatively high attention, the processing amount of a device such as a computer that is used to check the quality of the objects may increase, and the power consumption may increase. With the above information processing method, a notification is provided to the user when a difference between the design information and the measured information is included in the given range, and increase in the processing amount of a device such as a computer that is used for the check can be inhibited and increase in the power consumption can be inhibited.

For example, the providing of the notification may include: determining the given range to have a width according to a characteristic of the work and providing the notification using the given range determined.

With the above aspect, the width of the given range is adjusted according to the characteristic of the work, and therefore whether the notification is presented to the user is adjusted according to the characteristic of the work. As a result, the number of times the user checks the quality of the object with relatively high attention is more appropriately adjusted. With this, the information processing method can support more efficient management of the quality of work. For example, the providing of the notification may include:

determining the given range to have a narrower width for a larger information amount included in the image, and providing the notification using the given range determined.

With this aspect, whether the notification is provided to the user is adjusted according to variation in the amount of information in the image showing the target object of the work. As a result, the number of times the user checks the quality of the object with relatively high attention is adjusted more appropriately while placing a greater emphasis on checking the quality of work using an image with a relatively small amount of information. In this way, it is possible to support efficient management of the quality of work according to variation in the amount of information of the image.

For example, the information processing method further includes: obtaining a proficiency level in the work of a worker who has performed the work. The providing of the notification includes: determining the given range to have a narrower width for a higher proficiency level of a worker who has performed the work that serves as a basis for identifying the difference, and providing the notification using the given range determined.

With this aspect, whether the notification is provided to the user is adjusted according to the proficiency level of the worker who has performed the work. As a result, the number of times the user checks the quality with relatively high attention is more appropriately adjusted, while placing a greater emphasis on checking the quality of work performed by a worker with a relatively low proficiency level. In this way, it is possible to support efficient management of the quality of the work according to the proficiency level of the worker who has performed the work.

For example, the information processing method may further include: capturing the image by controlling an imaging device before the difference is identified; obtaining the measured information by performing image analysis processing on the image captured; and identifying the difference using the measured information obtained.

With this aspect, an image is captured by controlling an imaging device, and the difference between the design information and the measured information is identified based on the captured image. Therefore, the above difference can be identified using an image captured solely for the purpose of identifying the difference, and a more appropriate difference can be identified. Therefore, this can support more appropriate and efficient management of the quality of work.

For example, the information processing method may further include: obtaining a proficiency level in the work of a worker who has performed the work. The identifying of the difference includes: causing the imaging device to capture the image with a larger information amount for a lower proficiency level of a worker who is performing the work.

With this aspect, the amount of information in an image to be captured is adjusted according to the proficiency level of the worker who has performed the work. Since the amount of information is larger for a worker having a lower proficiency level, the accuracy of the measured information increases and a difference can be identified with higher accuracy. Accordingly, the notification is provided to the user more accurately. Therefore, this makes it possible to support more accurate and efficient management of the quality of work.

For example, the imaging device may be provided to a flying object to be operated by an operator.

With this aspect, a difference is identified using the image captured by the imaging device provided to the flying object and a notification is provided to the user. This makes it possible to identify a difference with higher accuracy using an image obtained by capturing the target object of the work from a more appropriate position and at a more appropriate angle to show the target object more appropriately. Accordingly, the notification is provided to the user more accurately. Therefore, this makes it possible to support more accurate and efficient management of the quality of work.

For example, the information processing method may further include: obtaining a proficiency level of the operator in operating the flying object. The identifying of the difference may include: causing the imaging device to capture the image with a larger information amount for a lower proficiency level of the operator.

With this aspect, the information amount of the image to be captured is adjusted according to the proficiency level of the operator of the flying object. Since the amount of information is larger for a worker having a lower proficiency level, the accuracy of the measured information increases and a difference can be identified with higher accuracy. Accordingly, the notification is provided to the user more accurately. Therefore, this makes it possible to support more accurate and efficient management of the quality of work.

For example, the information processing method may further include: obtaining a proficiency level of the operator in operating the flying object. The providing of the notification may include: determining the given range to have a narrower width for a higher proficiency level of the operator, and providing the notification using the given range determined.

With this aspect, the amount of information in an image to be captured is adjusted according to the proficiency level of the operator who operates the flying object. As a result, the number of times the user checks the quality with relatively high attention is more appropriately adjusted, while placing a greater emphasis on checking the quality of the work using the image captured when the flying object is operated by an operator having a relatively low proficiency level. In this way, it possible to support efficient management of the quality of work according to the proficiency level of the operator who has operated the flying object.

For example, the providing of the notification may further include providing the image to show the user the image provided.

With this aspect, the user can easily judge the quality of the work by seeing the image obtained by capturing the object on which the work has been performed. With this, the information processing method can support more easy management of the quality of work.

Moreover, an information processing device according to one aspect of the present disclosure includes: an obtainer that obtains design information regarding work, the design information including a reference value and an acceptable range that includes the reference value; an identifier that identifies a difference between the design information obtained and measured information regarding the work by comparing the design information with the measured information, the measured information being obtained from an image obtained by capturing an object on which the work has been performed; and a notifier that provides a notification to a user when the difference identified falls within a given range.

This aspect achieves the same effects as the above-described information processing method.

In addition, a recording medium according to one aspect of the present disclosure is a non-transitory computer-readable recording medium having recorded thereon a program for causing a computer to execute the above-described information processing method.

This aspect achieves the same effects as the above-described information processing method.

Note that these general or specific aspects may be implemented as a system, a device, an integrated circuit, a computer program, or a computer-readable recording medium such as a CD-ROM, or may be implemented as any combination of systems, devices, integrated circuits, computer programs, and recording media.

Hereinafter, an embodiment will be described in detail with reference to the drawings.

Note that each of the embodiments described below shows a general or specific example. The numerical values, shapes, materials, structural elements, the arrangement and connection of the structural elements, steps and the order of the steps, and the like mentioned in the following embodiments are mere examples and not intended to limit the present disclosure. Moreover, among the structural elements in the following embodiments, structural elements not recited in any one of the independent claims representing the broadest concepts are described as optional structural elements.

### Embodiment

The present embodiment describes an information processing method, an information processing device, and so on that support efficient management of the quality of work. The information processing method is also referred to as a support method, and the information processing device is also referred to as a support device.

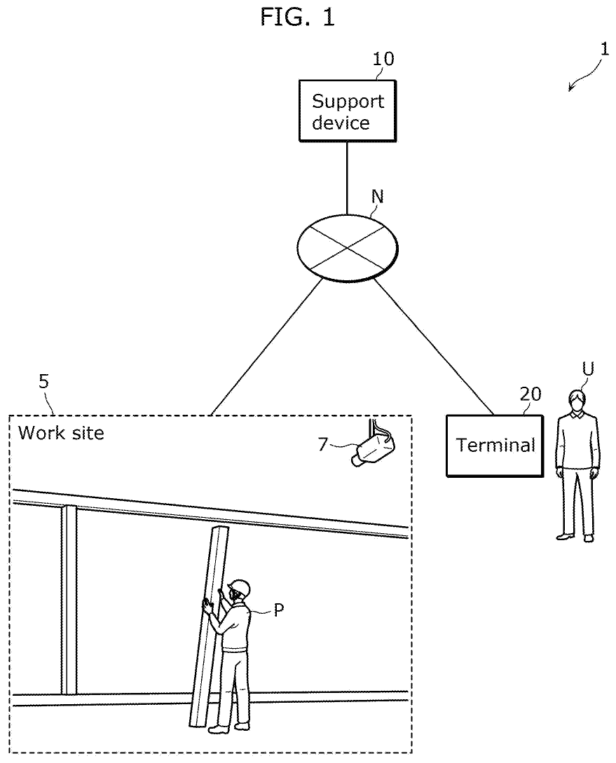

FIG. 1 is a schematic diagram illustrating a configuration of support system 1 according to the present embodiment.

Support system 1 illustrated in FIG. 1 is a system for user U to efficiently manage the quality of work performed by worker P at work site 5. User U is, for example, a manager who manages the quality of work performed at work site 5.

Support system 1 includes support device 10 and terminal 20. Moreover, support device 10 supports terminal 20 and a device disposed at work site 5 (for example, imaging device 7) through network N. Network N may include the Internet, cellular carrier networks, public networks, or local area networks.

Work site 5 is a place where work is performed by worker P.

Work site 5 is, for example, a construction site, and may also be referred to as a building site or a job site, etc. In work site 5, imaging device 7 that captures an image of a target object on which worker P has performed work (e.g., a pillar, a wall, a floor, a ceiling, a door, and other equipment) is disposed.

Imaging device 7 obtains an image by image capturing, and provides the image to support device 10. For example, the work is to connect a pillar, install a wall, or arrange equipment. Imaging device 7 can capture an image in accordance with the control signal received from support device 10 through network N. Imaging device 7 may be an imaging device with a pan, tilt, or zoom function. In this case, imaging device 7 changes the orientation of the lens by pan, tilt, or zoom in accordance with the control signal received from support device 10 through network N.

In addition, imaging device 7 may have a function to adjust imaging parameters (specifically, the number of dimensions [such as 2D or 3D], the resolution [such as High Definition (HD), 4K, or 8K]). In this case, imaging device 7 changes the imaging parameters in accordance with the control signal received from support device 10 through network N.

Note that FIG. 1 illustrates that imaging device 7 is attached to the ceiling of work site 5, but the present disclosure is not limited to this example. For example, imaging device 7 may be attached to a movable object that travels along the floor, wall, or ceiling, or to a flying object (so-called drone) that flies in the space of work site 5. A movable object may be an object that judges the surrounding situation and travels autonomously based on information indicating the surrounding situation sensed by a sensor, etc., or an object that travels by being operated by an operator. The operator may be on board or need not be on board the movable object.

Support device 10 is a device that supports user U in managing the quality of work. Support device 10 obtains the image obtained by imaging device 7 and, based on the obtained image, provides a notification regarding the work that has been performed by worker P and particularly needs to be checked by user U. The process performed by support device 10 will be described in more detail later.

Terminal 20 supports user U in managing the quality of work. As an example, the case where terminal 20 is located in a location different from work site 5 is described, but the present disclosure is not limited to this case. Terminal 20 may be located in work site 5. Terminal 20 may be a personal computer, a smartphone, or a tablet.

Terminal 20 presents an image of the object that is the target object on which worker P performed work at work site 5 to user U by displaying the image on the display screen. The image is, for example, an image captured by imaging device 7.

In addition, terminal 20 receives the notification provided by support device 10 regarding the work that particularly needs to be checked by user U. An image may also be provided together with the above notification. User U is expected to check with normal attention the overall work performed by worker P, and to check the work notified in the notification by support device 10 with higher attention than usual.

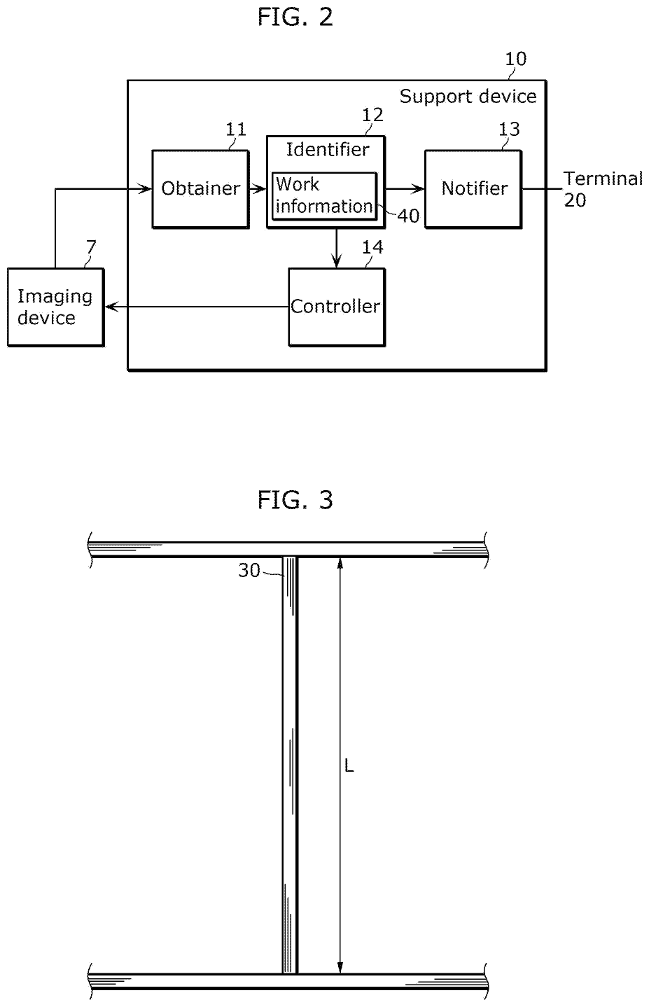

FIG. 2 is a block diagram illustrating a functional configuration of support device 10 according to the present embodiment.

As illustrated in FIG. 2, support device 10 includes obtainer 11, identifier 12, notifier 13, and controller 14 as functional components. The functional components of support device 10 can be implemented by a processor (for example, a central processing unit (CPU)) (not illustrated) included in support device 10 executing a predetermined program using memory (not illustrated).

Obtainer 11 is a functional component that obtains design information. The design information is predetermined design information regarding work, and includes a reference value and an acceptable range including the reference value. Moreover, obtainer 11 obtains an image captured by imaging device 7. In the image obtained by obtainer 11, an object that is a target object on which worker P has performed work is captured.

A reference value is information that indicates, for example, the dimensions, curvature, or angle (also referred to as dimensions, etc.) of an object. More specifically, the dimensions of an object may include the length, height, depth, thickness, or width of the object. The reference value indicates the dimensions, etc. of the object to be achieved by the work.

The acceptable range is a range that includes the reference value. In other words, it is a given range in which the reference value falls.

More specifically, the acceptable range includes a lower limit defined as a value smaller than the reference value by a given value (also commonly referred to as a lower tolerance), and an upper limit defined as a value larger than the reference value by a given value (also commonly referred to as an upper tolerance). The acceptable range indicates an acceptable range of the dimensions, etc. of an object to be achieved by the work. The acceptable range can also be said to indicate the accuracy required for the work, in other words, the degree to which the reference value is required to be achieved. The acceptable range generally includes, but is not limited to, a value equal to the upper limit or the lower limit. The upper tolerance and the lower tolerance may be different from each other.

Identifier 12 is a functional component that identifies a difference between the design information and the measured information. Identifier 12 compares the design information obtained by obtainer 11 with the measured information regarding the work to identify the difference between the design information and the measured information. The measured information is obtained from an image obtained by capturing an object on which the work has been performed.

The measured information includes measured values of the dimensions, etc. of an object. The difference between the design information and the measured information is, for example, a difference between a reference value included in the design information and a measured value included in the measured information, and this case is described as an example. Note that the above difference is, for example, the difference obtained by subtracting the reference value from the measured value. As other examples, it is also possible to use a value derived using a difference or a ratio between the measured value and the reference value.

When identifying a difference between design information and measured information, identifier 12 may obtain measured information by performing image analysis processing on the image captured in advance by imaging device 7 before identifying the difference, and use the obtained measured information to identify the difference. Imaging device 7 captures an image when a control signal for causing imaging device 7 to capture an image is transmitted from controller 14 to imaging device 7. In this case, imaging device 7 transmits to support device 10 the image generated by image capturing. Identifier 12 obtains the image transmitted as described above through obtainer 11 and performs the image analysis processing, etc. on the obtained image.

Moreover, when identifier 12 identifies a difference between the design information and the measured information, controller 14 may cause imaging device 7 to capture an image with a larger information amount for a lower proficiency level of a worker who is performing the work. In this case, it is assumed that identifier 12 has obtained proficiency level information indicating the proficiency level in the work of at least one worker who has performed the work. Here, a large amount of information may include a large number of dimensions, which are imaging parameters of the image, or a high resolution, which is an imaging parameter of the image. For example, an image with three dimensions (i.e., a 3D image) has a larger amount of information than an image with two dimensions (i.e., a 2D image) does. Moreover, an image with 2K resolution has a larger amount of information than an image with HD resolution does, and an image with 4K resolution has an even larger amount of information.

Moreover, when imaging device 7 is provided to a flying object and identifier 12 identifies a difference between the design information and the measured information, identifier 12 may cause imaging device 7 using controller 14 to capture an image with a larger information amount for a lower proficiency level of an operator of the flying object. In this case, it is assumed that identifier 12 has obtained proficiency level information indicating the proficiency level in operating the flying object of the operator who operates the flying object. Note that identifier 12 may control imaging device 7 using controller 14 as described above, and may control a flying object using controller 14.

Notifier 13 is a functional component that provides a notification to user U. Notifier 13 provides a notification to user U on terminal 20 when the difference between the design information and the measured information that is identified by identifier 12 falls within a given range. The given range is in a neighborhood of the upper limit or lower limit of the acceptable range if the reference value is set to zero. The given range is also referred to as a monitoring range (or first monitoring range) for difference.

Note that it can also be said that notifier 13 provides the notification when the measured information falls within a given range that in a neighborhood of the upper limit or the lower limit of the acceptable range included in the design information. The given range is also referred to as a monitoring range (or second monitoring range) for the measured information. The case where the measured information falls within the second monitoring range and the case where the difference between the design information and the measured information falls within the first monitoring range mean essentially the same. Note that the first monitoring range or the second monitoring range may be simply referred to as a monitoring range. In the following, the case where notifier 13 uses (i) the difference between the design information and the measured information and (ii) the first monitoring range will be described as an example.

If the difference between the design information and the measured information falls within the first monitoring range, it is not easy for user U to judge whether the measured information is included in the acceptable range, and user U should monitor the quality of work with a higher level of attention than usual. Therefore, it is assumed that the monitoring will be performed by user U when notifier 13 provides the notification.

The width of the monitoring range is less than the width of the acceptable range. The width of the monitoring range is, more specifically, within 10% to 20% of the width of the acceptable range, and more specifically, within a few percent.

In addition, when notifier 13 determines that the identified difference is included in the acceptable range and not included in the monitoring range, notifier 13 does not provide a notification to user U. In this case, it can be said that notifier 13 restricts provision of notification to user U. In this case, it is clear that the measured information is included in the acceptable range, and user U can easily judge that the quality of the work is greater than or equal to a certain level with usual attention of user U.

In addition, when notifier 13 determines that the identified difference is not included in the acceptable range and not included in the monitoring range, notifier 13 does not provide notification to user U. In this case, it can be said that notifier 13 restricts provision of notification to user U. In this case, it is clear that the measured information is not included in the acceptable range, and user U can easily judge that the quality of the work is less than a certain level with usual attention of user U.

Moreover, when providing a notification, notifier 13 may determine the monitoring range to have a width according to a characteristic of the work and provide the notification using the monitoring range determined.

Moreover, when providing the notification, notifier 13 may determine the monitoring range to have a narrower width for a larger information amount included in the image, and provide the notification using the monitoring range determined.

Moreover, when providing the notification, notifier 13 may determine the monitoring range to have a narrower width for a higher proficiency level of a worker who has performed the work that serves as a basis for identifying the difference, and provide the notification using the monitoring range determined. In this case, it is assumed that notifier 13 has obtained proficiency level information indicating the proficiency level in the work of at least one worker who has performed the work.

Moreover, when providing the notification, notifier 13 may determine the monitoring range to have a narrower width for a higher proficiency level of an operator of a flying object, and provide the notification using the monitoring range determined. In this case, it is assumed that notifier 13 has proficiency level information indicating the proficiency level in operating the flying object of the operator who operates the flying object.

Notifier 13 may further provide an image obtained by obtainer 11 to show the provided image to a person who performs monitoring.

Controller 14 is a functional component that controls imaging device 7. Controller 14 controls imaging device 7 by transmitting a control signal for controlling imaging device 7 to imaging device 7 through network N. The control signal is specifically a signal for controlling a pan, tilt, or zoom function of imaging device 7, or a signal for changing an imaging parameter.

Note that when imaging device 7 is provided to a flying object, controller 14 may control imaging device 7 and the flying object. Controller 14 controls the flying object by transmitting a control signal for controlling the flying object to the flying object through network N. Specifically, for example, the control signal is for controlling ascending, descending, advancing, right and left movement, or right and left rotation of a flying object. In this case, the flying object needs to be communicably connected to support device 10 through network N.

In the following, the information used by support device 10 will be described in detail.

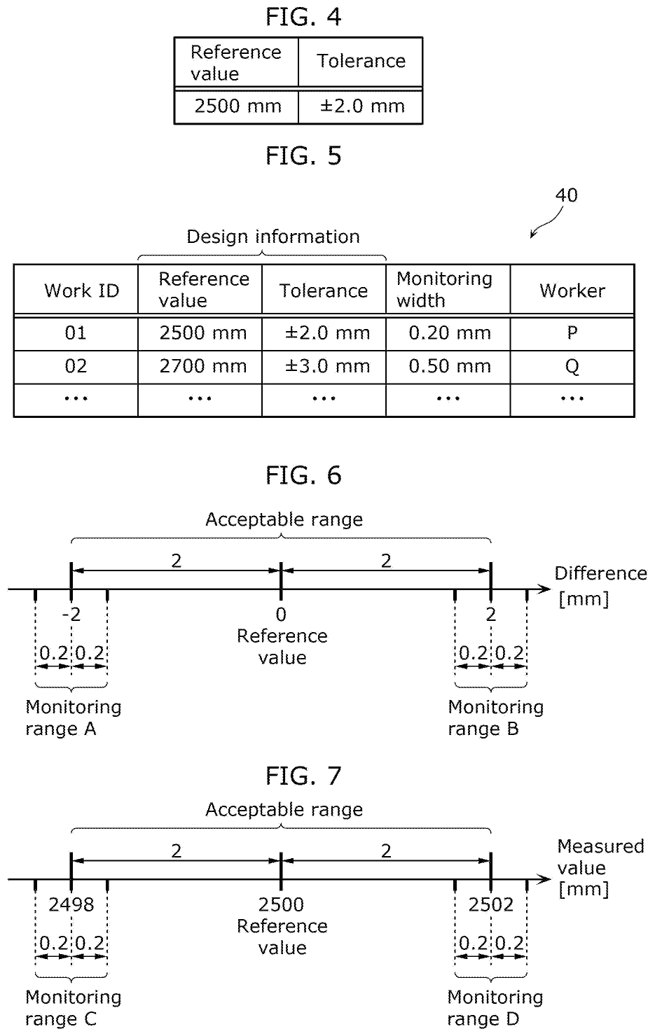

FIG. 3 is a schematic diagram illustrating an appearance of a pillar, which is an example of a target object of work. FIG. 4 is an explanatory table illustrating an example of design information in the present embodiment.

Pillar 30 illustrated in FIG. 3, which is an example of the target object of work, is a pillar having a length of L.

FIG. 4 is an explanatory table illustrating an example of design information in the present embodiment. The design information illustrated in FIG. 4 is information determined in advance according to a target object of work, and is an example of the design information obtained by obtainer 11.

The design information illustrated in FIG. 4 includes, for example, a reference value and an acceptable range for length L of pillar 30 illustrated in FIG. 3. For example, the reference value for length L is 2500 mm and the tolerance is ±2.0 mm (i.e., the upper tolerance is 2.0 mm and the lower tolerance is −2.0 mm).

Note that the design information may be information including a reference value and a tolerance. In this case, an acceptable range can be calculated using the reference value and the tolerance, and thus the acceptable range obtained in this manner can be used.

FIG. 5 is an explanatory table illustrating work information 40, which is an example of work information in the present embodiment. Work information 40 illustrated in FIG. 5 is an example of work information 40 possessed by identifier 12.

Work information 40 illustrated in FIG. 5 is information including a work ID, design information of the work, the monitoring width, and the worker for each work. One entry (one line) shown in FIG. 5 corresponds to one item of work.

The work ID is identification that can uniquely identify the work indicated in the entry. The work ID may be information in a form that can uniquely identify the work and may include numbers, letters, or symbols. Work having the work ID of 01 is also referred to as work 01. For example, work 01 is to connect a pillar and work 02 is to arrange equipment.

The design information includes a reference value and a tolerance for the work indicated in the entry. The design information corresponds to the design information shown in FIG. 4.

The monitoring width is information that defines a monitoring range for the work indicated in the entry. The monitoring range for difference (first monitoring range) includes, if the reference value is set to zero, a range whose lower limit is a value smaller than an upper limit of the acceptable range by a monitoring width, and whose upper limit is a value larger than the upper limit of the acceptable range by the monitoring width. Moreover, the monitoring range for difference includes, if the reference value is set to zero, a range whose lower limit is a value smaller than a lower limit of the acceptable range by the monitoring width, and whose upper limit is a value larger than the lower limit of the acceptable range by the monitoring width of the acceptable range.

Note that the monitoring range for measured information (second monitoring range) includes a range whose lower limit is a value smaller than an upper limit of an acceptable range by a monitoring width, and whose upper limit is a value larger than the upper limit of the acceptable range by the monitoring width. Moreover, the monitoring range for measured information includes a range whose lower limit is a value smaller than a lower limit of the acceptable range by the monitoring width, and whose upper limit is a value larger than the lower limit of the acceptable range by the monitoring width of the acceptable range.

The worker indicates a worker who has performed the work indicated in the entry.

A monitoring range determined by the monitoring width will be described in detail with reference to FIG. 6.

FIG. 6 is an explanatory diagram illustrating a first example of a monitoring range in the present embodiment.

Two monitoring ranges A and B shown in FIG. 6 are examples of the monitoring range for difference (first monitoring range) of a target object of work 01 shown in FIG. 5.

The two monitoring ranges A and B shown in FIG. 6 are used by notifier 13 to determine a difference between the design information and the measured information.

Monitoring range A is a range of (−2±0.2) mm, that is, a range from −2.2 mm to −1.8 mm, which is in a neighborhood of the lower limit of −2 mm of an acceptable range (from −2 mm to 2 mm) that is set based on the reference value that is assumed to be set to zero.

In addition, monitoring range B is a range of (2±0.2) mm, that is, a range from 1.8 mm to 2.2 mm, which is in a neighborhood of the upper limit of 2 mm of the acceptable range (from −2 mm to 2 mm).

Notifier 13 provides a notification to user U when the difference between the design information and the measured information falls within monitoring range A or B.

FIG. 7 is an explanatory diagram illustrating a second example of the monitoring range in the present embodiment.

Two monitoring ranges C and D shown in FIG. 7 are examples of the monitoring range for a measured value (second monitoring range) of the target object of work 01 shown in FIG. 5.

The two monitoring ranges C and D shown in FIG. 7 are used by notifier 13 to perform determination regarding the measured information.

Monitoring range C is a range of (2498±0.2) mm, that is, the range from 2497.8 mm to 2498.2 mm, which is in a neighborhood of the lower limit of 2498 mm of an acceptable range (2498 mm to 2502 mm) that is set based on the reference value of 2500 mm.

In addition, monitoring range C is a range of (2502±0.2) mm, that is, the range from 2501.8 mm to 2502.2 mm, which is in a neighborhood of the upper limit of 2502 mm of the acceptable range (from 2498 mm to 2502 mm).

Notifier 13 provides a notification to user U when the measured value falls within monitoring range C or D.

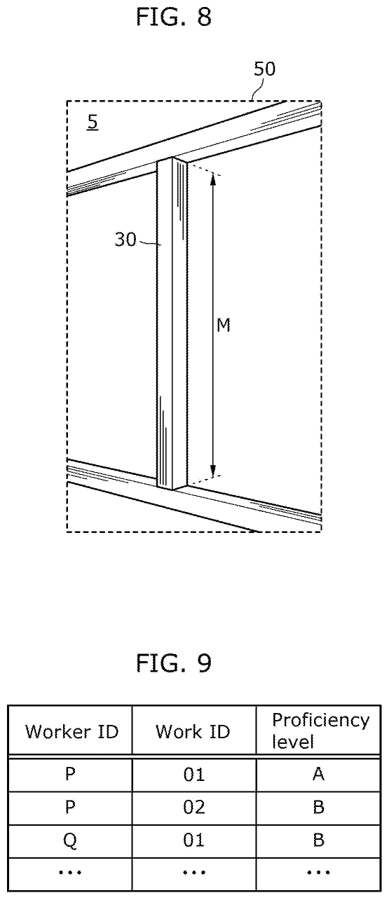

FIG. 8 is an explanatory diagram illustrating an example of measured information in the present embodiment.

Image 50 shown in FIG. 8 is an example of the image of pillar captured by imaging device 7. Pillar 30 is an object on which work has been performed at work site 5.

Identifier 12 obtains image 50 through obtainer 11, and performs image analysis processing on image 50 to identify actual length M of pillar 30 shown in image 50. Actual length M of pillar 30 may be identified by appropriate computation using the length of pillar 30 on image 50, the position in real space of imaging device 7 that has captured image 50, the imaging direction, imaging parameters, and the distance between imaging device 7 and pillar 30 in real space.

Identifier 12 determines whether measured information falls within the monitoring range (more specifically, the second monitoring range) by using, as measured information, actual length M of pillar identified as described above, and controls whether a notification is provided by notifier 13 depending on the result of the determination.

FIG. 9 is a table illustrating an example of proficiency level information in the present embodiment.

The proficiency level information shown in FIG. 9 can be used when identifier 12 controls imaging device 7 using controller 14, or when notifier 13 determines the width of the monitoring range. The proficiency level information may be possessed by, for example, identifier 12 or controller 14, but the present disclosure is not limited to this example. The proficiency level information may be possessed by other functional components of support device 10.

The proficiency level information shown in FIG. 9 is information indicating the proficiency level for each work description of a worker. One entry (one line) shown in FIG. 9 indicates the proficiency level regarding one item of work of one worker.

Proficiency level information includes a worker ID, work description, and a proficiency level.

A worker ID is identification that can uniquely identify the work indicated in the entry. A worker ID may be information in a form that can uniquely identify each worker and may include numbers, letters, or symbols.

A work ID is identification that can uniquely identify the work indicated in the entry. This work ID is the same as the work ID included in the work information (see FIG. 5).

The proficiency level refers to the proficiency level of a worker corresponding to the worker ID indicated in the entry of work corresponding to the work ID indicated in the entry. A proficiency level is expressed in, for example, one of three levels of A, B, or C, but the notation of the proficiency level is not limited to this example. In addition, the proficiency levels are not limited to 3 levels.

For example, the proficiency level information shown in FIG. 9 indicates that, regarding the worker whose worker ID is P (referred to as worker P), the proficiency level is A in the work having the work ID of 01 (referred to as work 01).

In addition, the proficiency level information shown in FIG. 9 indicates that the proficiency level in work 02 of worker P is B.

In addition, the proficiency level information shown in FIG. 9 indicates that the proficiency level in work 01 of worker Q is B.

Note that the proficiency level information may include the proficiency level of an operator who operates a flying object in operating the flying object. The proficiency level in operating a flying object can be used when identifier 12 controls imaging device 7 using controller 14, or when notifier 13 determines the width of the monitoring range.

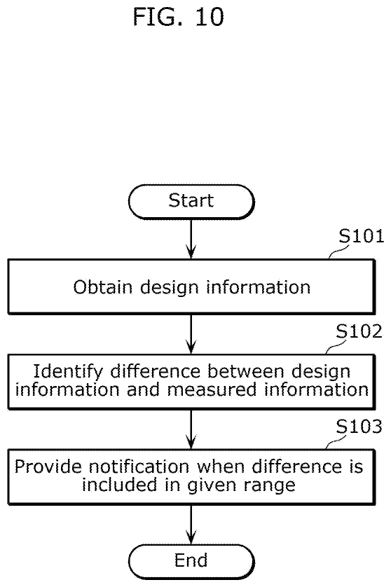

FIG. 10 is a flowchart illustrating a support method according to the present embodiment.

As illustrated in FIG. 10, in step S101, obtainer 11 obtains design information.

In step S102, identifier 12 compares the design information obtained in step S101 with measured information regarding work to identify a difference between the design information and the measured information.

In step S103, notifier 13 provides a notification to user U when the difference identified in step S102 is included in a given range (i.e., monitoring range) that is in a neighborhood of an upper limit or a lower limit of the acceptable range.

With the processes described above, support device 10 can manage the quality of work more efficiently.

Note that in the above embodiment, each of the structural elements may include dedicated hardware, or may be achieved by executing an appropriate software program for each structural element. Each structural element may be achieved by a program executor, such as a central processing unit (CPU) or a processor, reading and executing a software program recorded on a recording medium, such as a hard disk or semiconductor memory. Here, an example of the software that achieves the support device and so on according to the aforementioned embodiment includes the following program.

In other words, such a program is a program for causing a computer to execute an information processing method including: obtaining design information regarding work, the design information including a reference value and an acceptable range that includes the reference value; identifying a difference between the design information obtained and measured information regarding the work by comparing the design information with the measured information, the measured information being obtained from an image obtained by capturing an object on which the work has been performed; and providing a notification to a user when the difference identified falls within a given range that is in a neighborhood of an upper limit or a lower limit of the acceptable range.

The support device and so on according to the present disclosure have been described based on the above-described embodiment. However, the present disclosure should not be limited to the embodiment. Various modifications of the present embodiments as well as embodiments resulting from combinations of the structural elements and functions of the embodiments that may be conceived by those skilled in the art may be included within the scope of one or more aspects, as long as these do not depart from the scope of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to systems that manage the quality of work.

1. An information processing method comprising:
obtaining design information regarding work, the design information including a reference value and an acceptable range that includes the reference value;
identifying a difference between the design information obtained and measured information regarding the work by comparing the design information with the measured information, the measured information being obtained from an image obtained by capturing an object on which the work has been performed; and
providing a notification to a user when the difference identified falls within a given range that is in a neighborhood of an upper limit or a lower limit of the acceptable range.

2. The information processing method according to claim 1, wherein
the providing of the notification includes:
determining the given range to have a width according to a characteristic of the work and providing the notification using the given range determined.

3. The information processing method according to claim 1, wherein
the providing of the notification includes:
determining the given range to have a narrower width for a larger information amount included in the image, and providing the notification using the given range determined.

4. The information processing method according to claim 1, further comprising:
obtaining a proficiency level in the work of a worker who has performed the work, wherein
the providing of the notification includes:
determining the given range to have a narrower width for a higher proficiency level of a worker who has performed the work that serves as a basis for identifying the difference, and providing the notification using the given range determined.

5. The information processing method according to claim 1, further comprising:
capturing the image by controlling an imaging device before the difference is identified;
obtaining the measured information by performing image analysis processing on the image captured; and
identifying the difference using the measured information obtained.

6. The information processing method according to claim 5, further comprising:
obtaining a proficiency level in the work of a worker who has performed the work, wherein
the identifying of the difference includes:
causing the imaging device to capture the image with a larger information amount for a lower proficiency level of a worker who is performing the work.

7. The information processing method according to claim 5, wherein
the imaging device is provided to a flying object to be operated by an operator.

8. The information processing method according to claim 7, further comprising:
obtaining a proficiency level of the operator in operating the flying object, wherein
the identifying of the difference includes:
causing the imaging device to capture the image with a larger information amount for a lower proficiency level of the operator.

9. The information processing method according to claim 7, further comprising:
obtaining a proficiency level of the operator in operating the flying object, wherein
the providing of the notification includes:
determining the given range to have a narrower width for a higher proficiency level of the operator, and providing the notification using the given range determined.

10. The information processing method according to claim 1, wherein
the providing of the notification further includes providing the image to show the user the image provided.

11. An information processing device comprising:
an obtainer that obtains design information regarding work, the design information including a reference value and an acceptable range that includes the reference value;
an identifier that identifies a difference between the design information obtained and measured information regarding the work by comparing the design information with the measured information, the measured information being obtained from an image obtained by capturing an object on which the work has been performed; and
a notifier that provides a notification to a user when the difference identified falls within a given range.

12. A non-transitory computer-readable recording medium having recorded thereon a program for causing a computer to execute the information processing method according to claim 1.
